(19) United States
(12) Patent Application Publication
(10) Pub. No.: US 2012/0133576 A1
(43) Pub. Date: May 31, 2012

(54) LIQUID CRYSTAL DISPLAY DEVICE CIRCUIT, LIQUID CRYSTAL DISPLAY DEVICE BOARD, AND LIQUID CRYSTAL DISPLAY DEVICE

(75) Inventors: Tsuyoshi Kamada, Osaka-shi (JP); Shohei Katsuta, Osaka-shi (JP); Tetsuya Ide, Osaka-shi (JP); Seiji Ohhashi, Osaka-shi (JP)

(73) Assignee: SHARP KABUSHIKI KAISHA, Osaka-shi, Osaka (JP)

(21) Appl. No.: 13/386,778

(22) PCT Filed: Aug. 26, 2010
(86) PCT No.: PCT/JP2010/064525

§ 371 Date: Jan. 24, 2012

(30) Foreign Application Priority Data
Oct. 21, 2009 (JP) 2009-242472

(51) Int. Cl. G09G 3/36

(52) U.S. Cl. 345/87

(57) ABSTRACT

A liquid crystal display device circuit disclosed includes: a first output transistor (Mo1n+1) having (i) a gate electrode connected to an (n+1)th gate bus line or a gate bus line subsequent to the (n+1)th gate bus line, (ii) a drain electrode connected to a first capacitor (Cb1n+1), and (iii) a source electrode connected to a first pixel electrode (PE1n); and a second output transistor (Mo2n−1) having (i) a gate electrode connected to an (n−1)th gate bus line or a gate bus line preceding the (n−1)th gate bus line, (ii) a drain electrode connected to a second end of the second capacitor (Cb2n−1), and (iii) a source electrode connected to a second pixel electrode (PE2n). This produces a liquid crystal display device circuit that can both reduce power consumption and have a good viewing angle characteristic regardless of whether the scan direction is a forward direction or a backward direction.

### TECHNICAL FIELD

The present invention relates to (i) a liquid crystal display device circuit for use in, for example, a liquid crystal display section of an electronic device and (ii) a liquid crystal display device board in which the liquid crystal display device circuit is provided.

### BACKGROUND ART

Recent years have witnessed active use of liquid crystal display devices. A liquid crystal display device is required to have a good viewing angle characteristic that allows a user to view a display screen from various angles.

An example known method for achieving a good viewing angle characteristic is to simply divide each pixel into a plurality of sub-pixels and apply different voltages to the respective sub-pixels.

Patent Literature 1 discloses a liquid crystal display device in which (i) each pixel includes a first sub-pixel and a second sub-pixel and (ii) changing the voltage of a CS bus line (storage capacitor line) to which an auxiliary capacitor is connected allows different voltages to be applied to the respective first and second sub-pixels.

This liquid crystal display device allows different voltages to be applied to the respective first and second sub-pixels, and can thus have a good viewing angle characteristic. This liquid crystal display device is, on the other hand, problematic in that since it needs to change the voltage of a CS bus line, the liquid crystal display device consumes a large amount of power.

Recent years have also witnessed active use of a portable liquid crystal display device including a rotatable liquid crystal display section. Such a liquid crystal display device is required to, even when the liquid crystal display section is held in an inverted position, carry out a display that keeps the original top side of an image at the top. Such a liquid crystal display device is also required to have both reduced power consumption and a good viewing angle characteristic.

Patent Literature 2 discloses a liquid crystal display device board that includes: a first pixel electrode and a second pixel electrode both connected to an n-th gate bus line via a TFT; and a TFT including (i) a gate electrode connected to an (n+1)th gate bus line, (ii) a source electrode connected to the second pixel electrode, and (iii) a drain electrode connected to a first end of a buffer capacitor having a second end connected to a storage capacitor bus line.

This liquid crystal display device board, without use of a separate member for changing the potential of the storage capacitor bus line, allows a voltage applied to the second pixel electrode to be lower than a voltage applied to the first pixel electrode. This liquid crystal display device board can thus have both reduced power consumption and a good viewing angle characteristic.

### CITATION LIST

### Patent Literature 1

Japanese Patent Application Publication, Tokukai, No. 2004-62146 A (Publication Date: Feb. 26, 2004)

### Patent Literature 2

Japanese Patent Application Publication, Tokukai, No. 2006-133577 A (Publication Date: May 25, 2006)

### SUMMARY OF INVENTION

### Technical Problem

The above liquid crystal display device board can, in the case where the scan direction is a forward direction, cause a voltage applied to the second pixel electrode to be lower than a voltage applied to the first pixel electrode. However, in the case where the scan direction is a backward direction, the liquid crystal display device board cannot lower a voltage applied to the second pixel electrode.

The liquid crystal display device board is thus problematic in that a liquid crystal display device including this liquid crystal display device board cannot have an improved viewing angle characteristic when the liquid crystal display section is held in an inverted position and the scan direction is consequently a backward direction.

The present invention has been accomplished in view of the above problem. It is an object of the present invention to produce a liquid crystal display device circuit that can both reduce power consumption and have a good viewing angle characteristic regardless of whether the scan direction is a forward direction or a backward direction.

### Solution to Problem

In order to solve the above problem, a liquid crystal display device circuit of the present invention includes: a plurality of gate bus lines; a plurality of drain bus lines provided so as to be electrically separated from the plurality of gate bus lines and cross the plurality of gate bus lines; a plurality of storage capacitor bus lines provided in parallel to the plurality of gate bus lines; and in a pixel region defined by an n-th gate bus line among the plurality of gate bus lines and an m-th drain bus line among the plurality of drain bus lines, (i) at least one first sub-unit and (ii) a second sub-unit present in a number equal to a number of the at least one first sub-unit, the at least one first sub-unit including: a first pixel electrode; a first input transistor having (i) a gate electrode connected to the n-th gate bus line, (ii) a drain electrode connected to the m-th drain bus line, and (iii) a source electrode connected to the first pixel electrode; a first capacitor having a first end connected to a storage capacitor bus line among the plurality of storage capacitor bus lines; and a first output transistor having (i) a gate electrode connected to either a (n+1)th gate bus line or a gate bus line subsequent to the (n+1)th gate bus line among the plurality of gate bus lines, (ii) a drain electrode connected to a second end of the first capacitor, and (iii) a source electrode connected to the first pixel electrode, the second sub-unit including: a second pixel electrode; a second input transistor having (i) a gate electrode connected to the n-th gate bus line, (ii) a drain electrode connected to the m-th drain bus line, and (iii) a source electrode connected to the second pixel electrode; a second capacitor having a first end connected to a storage capacitor bus line among the plurality of storage capacitor bus lines; and a second output transistor having (i) a gate electrode connected to either an (n−1)th gate bus line or a gate bus line preceding the (n−1)th gate bus line among the plurality of gate bus lines, (ii) a drain electrode connected to a second end of the second capacitor, and (iii) a source electrode connected to the second pixel electrode.

In the above-arranged liquid crystal display device circuit of the present invention, a gate signal supplied to the n-th gate bus line sets the first input transistor and the second input transistor to a conductive state, which causes an electric charge to be supplied from the m-th drain bus line to the first pixel electrode and the second pixel electrode. This in turn causes both the potential of the first pixel electrode and the potential of the second pixel electrode to be equal to the potential of the drain bus line.

In the case where the scan direction is a forward direction, gate signals are then sequentially supplied to the (n+1)th gate bus line and its subsequent gate bus lines among the plurality of gate bus lines. This sets the first output transistor to a conductive state, which causes the electric charge stored in the first pixel electrode to be dispersed to the first capacitor, thus decreasing the potential of the first pixel electrode. The potential of the second pixel electrode, on the other hand, remains unchanged. This operation consequently causes a potential difference to be generated between the potential of the first pixel electrode and the potential of the second pixel electrode.

In the case where the scan direction is a backward direction, after a gate signal is supplied to the n-th gate bus line, gate signals are sequentially supplied to the (n−1)th gate bus line and its subsequent gate bus lines among the plurality of gate bus lines. This sets the second output transistor to a conductive state, which causes the electric charge stored in the second pixel electrode to be dispersed to the second capacitor, thus decreasing the potential of the second pixel electrode. The potential of the first pixel electrode, on the other hand, remains unchanged. This operation consequently causes a potential difference to be generated between the potential of the first pixel electrode and the potential of the second pixel electrode.

The above-arranged liquid crystal display device circuit, as described above, can cause a potential difference to be generated between the potential of the first pixel electrode and the potential of the second pixel electrode regardless of whether the scan direction is a forward direction or a backward direction.

Further, the above-arranged liquid crystal display device circuit can cause a potential difference to be generated between the potential of the first pixel electrode and the potential of the second pixel electrode without changing the potential of a storage capacitor bus line.

It is known that generating a potential difference between respective potentials of adjacent pixels can improve a viewing angle characteristic.

Thus, the above-arranged liquid crystal display device circuit can both reduce power consumption and have a good viewing angle characteristic regardless of whether the scan direction is a forward direction or a backward direction.

A liquid crystal display device circuit of the present invention includes: a plurality of gate bus lines; a plurality of drain bus lines provided so as to be electrically separated from the plurality of gate bus lines and cross the plurality of gate bus lines; a plurality of storage capacitor bus lines provided in parallel to the plurality of gate bus lines; and in a pixel region defined by an n-th gate bus line among the plurality of gate bus lines and an m-th drain bus line among the plurality of drain bus lines, (i) at least one first sub-unit and (ii) at least one second sub-unit, the at least one first sub-unit including: a first pixel electrode; a first input transistor having (i) a gate electrode connected to the n-th gate bus line, (ii) a drain electrode connected to the m-th drain bus line, and (iii) a source electrode connected to the first pixel electrode; a first capacitor having a first end connected to a storage capacitor bus line among the plurality of storage capacitor bus lines; a first output transistor having (i) a gate electrode connected to either a (n+1)th gate bus line or a gate bus line subsequent to the (n+1)th gate bus line among the plurality of gate bus lines, (ii) a drain electrode connected to a second end of the first capacitor, and (iii) a source electrode connected to the first pixel electrode; a second capacitor having a first end connected to a storage capacitor bus line among the plurality of storage capacitor bus lines; and a second output transistor having (i) a gate electrode connected to either an (n−1)th gate bus line or a gate bus line preceding the (n−1)th gate bus line among the plurality of gate bus lines, (ii) a drain electrode connected to a second end of the second capacitor, and (iii) a source electrode connected to the first pixel electrode, the at least one second sub-unit including: a second pixel electrode; and a second input transistor having (i) a gate electrode connected to the n-th gate bus line, (ii) a drain electrode connected to the m-th drain bus line, and (iii) a source electrode connected to the second pixel electrode.

In the above-arranged liquid crystal display device circuit of the present invention, a gate signal supplied to the n-th gate bus line sets the first input transistor and the second input transistor to a conductive state, which causes an electric charge to be supplied from the m-th drain bus line to the first pixel electrode and the second pixel electrode. This in turn causes both the potential of the first pixel electrode and the potential of the second pixel electrode to be equal to the potential of the drain bus line.

In the case where the scan direction is a forward direction, gate signals are then sequentially supplied to the (n+1)th gate bus line and its subsequent gate bus lines among the plurality of gate bus lines. This sets the first output transistor to a conductive state, which causes the electric charge stored in the first pixel electrode to be dispersed to the first capacitor, thus decreasing the potential of the first pixel electrode. The potential of the second pixel electrode, on the other hand, remains unchanged. This operation consequently causes a potential difference to be generated between the potential of the first pixel electrode and the potential of the second pixel electrode.

In the case where the scan direction is a backward direction, after a gate signal is supplied to the n-th gate bus line, gate signals are sequentially supplied to the (n−1)th gate bus line and its subsequent gate bus lines among the plurality of gate bus lines. This sets the second output transistor to a conductive state, which causes the electric charge stored in the first pixel electrode to be dispersed to the second capacitor, thus decreasing the potential of the first pixel electrode. The potential of the second pixel electrode, on the other hand, remains unchanged. This operation consequently causes a potential difference to be generated between the potential of the first pixel electrode and the potential of the second pixel electrode.

It is commonly known that to achieve an optimal view characteristic, the area of the first pixel electrode and the area of the second pixel electrode desirably have an area ratio of 1:1.5 to 1:3. Further, to retain a gamma characteristic along a front direction and a view characteristic, (i) the area of the first pixel electrode and the area of the second pixel electrode preferably have an area ratio that is unchanged regardless of a change in the scan direction, and (ii) the larger one of the area of the first pixel electrode and the area of the second pixel electrode preferably remains as such regardless of a change in the scan direction. In addition, to retain the above characteristics, (i) the potential of the first pixel electrode and the potential of the second pixel electrode desirably have a potential difference that is unchanged regardless of a change in the scan direction, and (ii) the higher one of the potential of the first pixel electrode and the potential of the second pixel electrode desirably remains as such regardless of a change in the scan direction.

The above-arranged liquid crystal display device circuit can cause a potential difference to be generated between the potential of the first pixel electrode and the potential of the second pixel electrode regardless of whether the scan direction is a forward direction or a backward direction.

The above configuration allows (i) the area of the first pixel electrode and the area of the second pixel electrode to have an area ratio that is unchanged even if the scan direction is switched and (ii) the larger one of the area of the first pixel electrode and the area of the second pixel electrode to remain as such even if the scan direction is switched. Further, the above configuration allows (i) the potential of the first pixel electrode and the potential of the second pixel electrode to have a potential difference that is unchanged even if the scan direction is switched and (ii) the higher one of the potential of the first pixel electrode and the potential of the second pixel electrode to remain as such even if the scan direction is switched.

The above configuration thus can retain a gamma characteristic along a front direction and a view characteristic even if the scan direction is switched.

Further, the above-arranged liquid crystal display device circuit can cause a potential difference to be generated between the potential of the first pixel electrode and the potential of the second pixel electrode without changing the potential of a storage capacitor bus line.

Thus, the above-arranged liquid crystal display device circuit can both reduce power consumption and have a good viewing angle characteristic regardless of whether the scan direction is a forward direction or a backward direction.

### Advantageous Effects of Invention

As described above, the liquid crystal display device circuit of the present invention can both reduce power consumption and have a good viewing angle characteristic regardless of whether the scan direction is a forward direction or a backward direction.

### BRIEF DESCRIPTION OF DRAWINGS

FIG. 1

FIG. 1 is a circuit diagram illustrating a configuration of a liquid crystal display device circuit of a first embodiment of the present invention.

FIG. 2

FIG. 2 is a diagram schematically illustrating a configuration of a liquid crystal display device of the first embodiment of the present invention.

FIG. 3

FIG. 3 is a diagram schematically illustrating a configuration of a TFT substrate of the first embodiment of the present invention.

FIG. 4

FIG. 4 is a diagram illustrating an operation of the liquid crystal display device circuit of the first embodiment of the present invention for a case in which the scan direction is a forward direction, where (a) illustrates a waveform of a data potential applied by a drain bus line driving circuit to a drain bus line, (b) illustrates a waveform of a gate potential applied to an (n−1)th gate bus line, (c) illustrates a waveform of a gate potential applied to an n-th gate bus line, and (d) illustrates a waveform of a gate potential applied to an (n+1)th gate bus line.

FIG. 5

FIG. 5 is a diagram illustrating an operation of the liquid crystal display device circuit of the first embodiment of the present invention for a case in which the scan direction is a backward direction, where (a) illustrates a waveform of a data potential applied by a drain bus line driving circuit to a drain bus line, (b) illustrates a waveform of a gate potential applied to an (n−1)th gate bus line, (c) illustrates a waveform of a gate potential applied to an n-th gate bus line, and (d) illustrates a waveform of a gate potential applied to an (n+1)th gate bus line.

FIG. 6

FIG. 6 is a diagram illustrating the results of simulating an operation of the liquid crystal display device circuit of the first embodiment of the present invention on the basis of a SPICE, where (a) shows a circuit configuration and parameter values used in the simulation for a case in which the scan direction is a forward direction, (b) illustrates the results of the simulation for a case in which the scan direction is a forward direction, (c) shows a circuit configuration and parameter values used in the simulation for a case in which the scan direction is a backward direction, and (d) illustrates the results of the simulation for a case in which the scan direction is a backward direction.

FIG. 7

FIG. 7 is a circuit diagram illustrating a configuration of a liquid crystal display device circuit of a variation of the first embodiment of the present invention.

FIG. 8

FIG. 8 is a circuit diagram illustrating a configuration of a liquid crystal display device circuit of a second embodiment of the present invention.

FIG. 9

FIG. 9 is a diagram illustrating the results of simulating an operation of the liquid crystal display device circuit of the second embodiment of the present invention on the basis of a SPICE, where (a) shows a circuit configuration and parameter values used in the simulation, (b) illustrates the results of the simulation for a case in which the scan direction is a forward direction, and (c) illustrates the results of the simulation for a case in which the scan direction is a backward direction.

FIG. 10

FIG. 10 is a circuit diagram illustrating a configuration of a liquid crystal display device circuit of a variation of the second embodiment of the present invention.

### DESCRIPTION OF EMBODIMENTS

### Embodiment 1

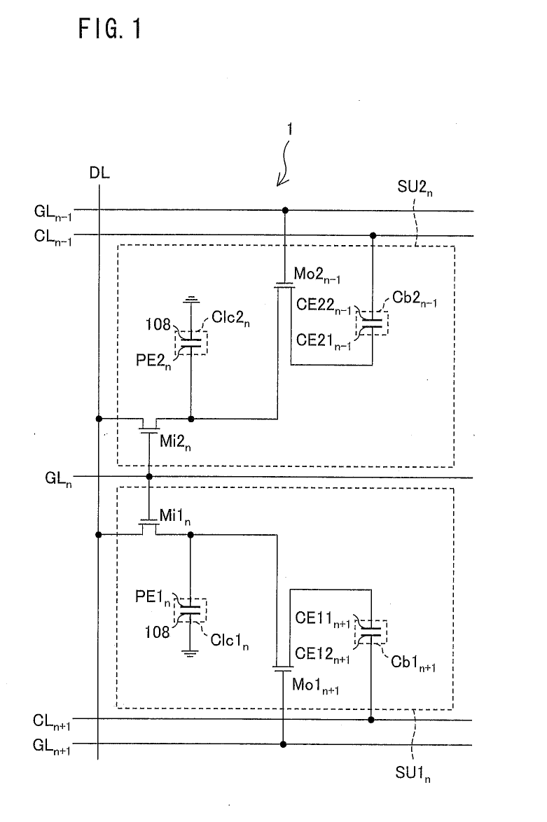

The following describes, with reference to FIGS. 1 through 3, respective configurations of (i) a liquid crystal display device 100, (ii) a TFT substrate (liquid crystal display device board) 10, and (iii) a liquid crystal display device circuit 1 provided in the TFT substrate 10, each in accordance with the present embodiment.

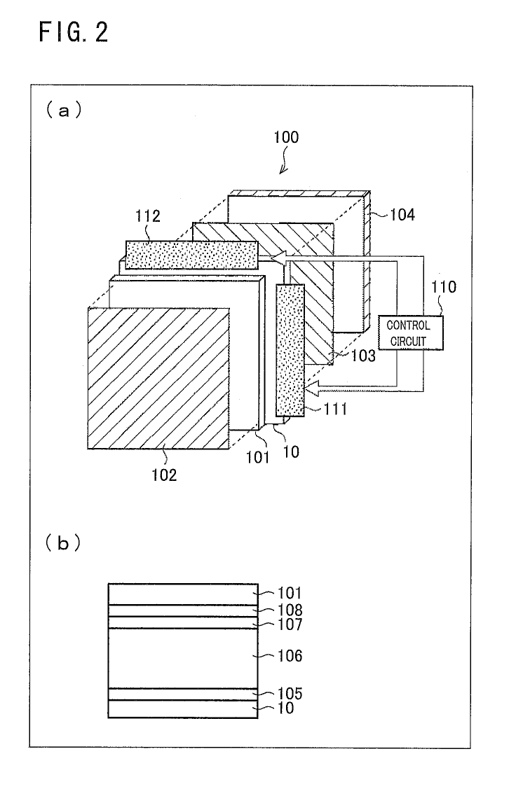

(a) and (b) of FIG. 2 each schematically illustrate the configuration of the liquid crystal display device 100 of the present embodiment. The liquid crystal display device 100, as illustrated in (a) of FIG. 2, includes: the TFT substrate 10; a counter substrate 101; a polarizing plate 102; a polarizing plate 103; a backlight unit 104; and a control circuit 110.

The TFT substrate 10 is an active matrix liquid crystal display device board, and includes (i) gate bus lines and (ii) drain bus lines separated from the gate bus lines by an insulating film and crossing the gate bus lines. Further, the TFT substrate 10 includes two pixel electrodes in each of individual pixel regions defined by the gate bus lines and the drain bus lines. As described below, applying different potentials to the two respective pixel electrodes prevents an image from looking washed out when viewed in an oblique direction, and thus achieves a good viewing angle characteristic.

The TFT substrate 10 includes, in each of the pixel regions, a switching element that switches, in correspondence with the value of a gate potential applied to a corresponding gate bus line, between (i) a conductive state, in which an electric current flows between a corresponding drain bus line and each pixel electrode, and (ii) a non-conductive state, in which no electric current flows therebetween. The above switching element is, for example, a TFT (thin film transister). The TFT substrate 10 further includes storage capacitor bus lines provided in parallel to the gate bus lines.

The TFT substrate 10 is, as illustrated in (a) of FIG. 2, connected to (i) a gate bus line driving circuit 111 in which is mounted a driver for driving the gate bus lines and (ii) a drain bus line driving circuit 112 in which is mounted a driver for driving the drain bus lines. The driving circuit 111 applies a gate potential to the gate bus lines in response to a predetermined signal supplied from the control circuit 110. The driving circuit 112 applies a data potential to the drain bus lines in response to a predetermined signal supplied from the control circuit 110.

As illustrated in (a) of FIG. 2, the polarizing plate 103 is provided to face a surface of the TFT substrate 10 which surface is opposite to a surface on which the TFTs are provided, whereas the polarizing plate 102 is provided to (i) face a surface of the counter substrate 101 which surface is opposite to a surface on which a common electrode is provided and (ii) meet a crossed Nicols relation with respect to the polarizing plate 103. The backlight unit 104 is provided to face a surface of the polarizing plate 103 which surface is opposite to a surface which faces the TFT substrate 10.

(b) of FIG. 2 is a cross-sectional view illustrating in more detail a structure provided between the TFT substrate 10 and the counter substrate 101.

As illustrated in (b) of FIG. 2, there are provided between the TFT substrate 10 and the counter substrate 101 (i) an alignment film 105, (ii) a liquid crystal layer 106, (iii) an alignment film 107, and (iv) a common electrode 108.

The alignment film 105 and the alignment film 106 serve to regulate alignment of liquid crystal molecules contained in the liquid crystal layer 106. In the present embodiment, the liquid crystal molecules contained in the liquid crystal layer 106 are aligned in a direction substantially perpendicular to the TFT substrate 10 in the case where the data potential applied to pixel electrodes has a value of 0.

In the case where the data potential applied to a drain bus line has a value other than 0, the data potential causes a potential difference between corresponding pixel electrodes and the common electrode 108. This potential difference changes the alignment of liquid crystal molecules contained in the liquid crystal layer 106.

As described below, there is provided a liquid crystal capacitor between the common electrode 108 and each pixel electrode.

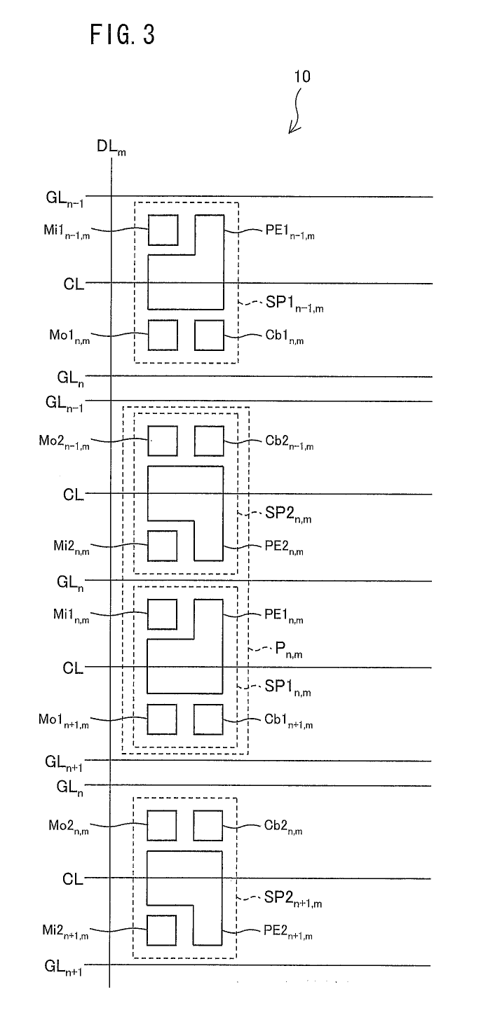

FIG. 3 is a diagram schematically illustrating the gate bus lines, the drain bus lines, and the storage capacitor bus lines all provided in the TFT substrate 10, and the pixel regions P defined by the gate bus lines and the drain bus lines.

As described above, the gate bus line driving circuit 111 applies a gate potential to the gate bus lines, whereas the drain bus line driving circuit 112 applies a data potential to the drain bus lines. The storage capacitor bus lines are each maintained at a constant potential, for example, at 0 volts.

The description below uses the term “gate bus line GLn” to refer to an n-th gate bus line, the term “storage capacitor bus line CLn” to refer to an n-th storage capacitor bus line, and the term “drain bus line DLm” to refer to an m-th drain bus line. The description below further uses the term “pixel region Pn,m” to refer to a pixel region P defined by the gate bus line GLn and the drain bus line DLm.

The pixel region Pn,m, as illustrated in FIG. 3, includes a sub-pixel region SP1n,m and a sub-pixel region SP2n,m.

There are provided in the sub-pixel region SP1n,m (i) a pixel electrode PE1n,m, (ii) an input transistor Mi1n,m, (iii) an output transistor Mo1n+1,m, and (iv) a capacitor Cb1n+1,m. Similarly, there are provided in the sub-pixel region SP2n,m (i) a pixel electrode PE2n,m, (ii) an input transistor Mi2n,m, (iii) an output transistor Mo2n−1,m, and (iv) a capacitor Cb2n−1,m.

The present embodiment uses a TFT for each of (i) the input transistor Mi1n,m, (ii) the output transistor Mo1n+1,m, (iii) the input transistor Mi2n,m, and (iv) the output transistor Mo2n−1,m.

FIG. 3 further illustrates (i) a sub-pixel region SP2n+1,m that belongs to a pixel region Pn+1,m defined by a gate bus line GLn+1 and the drain bus line DLm and (ii) a sub-pixel region SP1n−1,m that belongs to a pixel region Pn−1,m defined by a gate bus line GLn−1 and the drain bus line DLm.

FIG. 3 illustrates two gate bus lines GLn−1 intersecting with the drain bus line DLm. This illustration, however, does not necessarily indicate that the two gate bus lines GLn−1 are present independently of each other. This applies also to the two gate bus lines GLn+1. Further, FIG. 3 illustrates three gate bus line GLn intersecting with the drain bus line DLm. This illustration, however, does not necessarily indicate that the three gate bus lines GLn are present independently of one another.

FIG. 3 omits subscripts for the storage capacitor bus lines CL.

FIG. 1 is a circuit diagram illustrating a configuration of a pixel region Pn,m in the liquid crystal display device circuit 1 provided in the TFT substrate 10. The subscript “m” for specifying the ordinal number of a drain bus line DL is omitted below for a simple description.

The liquid crystal display device circuit 1, as illustrated in FIG. 1, includes (i) a sub-unit SU1n corresponding to the sub-pixel region SP1n and (ii) a sub-unit SU2n corresponding to the sub-pixel region SP2n.

The sub-unit SU1n supplies an electric charge from the drain bus line DL to the pixel electrode PE1n in correspondence with the value of a potential applied to the gate bus line GLn. Further, the sub-unit SU1n decreases the potential difference between the potential of the pixel electrode PE1n and the potential of the common electrode 108 in correspondence with the value of a potential applied to the gate bus line GLn+1.

The sub-unit SU1n, as illustrated in FIG. 1, includes (i) the pixel electrode PE1n, (ii) the input transistor Mi1n, (iii) the output transistor Mo1n+1, and (iv) the capacitor Cb1n+1.

The input transistor Mi1n is a transistor that, in correspondence with the value of a gate potential applied to the gate bus line GLn, (i) permits an electric current to flow between the drain bus line DLm and the pixel electrode PE1n or (ii) blocks such an electric current therebetween. The input transistor Mi1n, as illustrated in FIG. 1, includes: a gate electrode connected to the gate bus line GLn; a drain electrode connected to the drain bus line DL; and a source electrode connected to the pixel electrode PE1n.

The capacitor Cb1n+1 includes: a capacitor electrode CE11n+1; and a capacitor electrode CE12n+1 provided to face the capacitor electrode CE11n+1 and connected to a storage capacitor bus line CLn+1.

The output transistor Mo1n+1 is a transistor that, in correspondence with the value of a gate potential applied to the gate bus line GLn+1, (i) permits an electric current to flow between the capacitor electrode CE11n+1 and the pixel electrode PE1n or (ii) blocks such an electric current therebetween. The output transistor Mo1n+1, as illustrated in FIG. 1, includes: a gate electrode connected to the gate bus line GLn+1; a drain electrode connected to the capacitor electrode CE11n+1; and a source electrode connected to the pixel electrode PE1n.

The pixel electrode PE1n and the common electrode 108 (see (a) of FIG. 2) form a liquid crystal capacitor Clc1n therebetween.

Similarly to the sub-unit SU1n, the sub-unit SU2n supplies an electric charge from the drain bus line DL to the pixel electrode PE2n in correspondence with the value of a potential applied to the gate bus line GLn. Further, the sub-unit SU2n decreases the potential difference between the potential of the pixel electrode PE2n and the potential of the common electrode 108 in correspondence with the value of a potential applied to the gate bus line GLn−1.

The sub-unit SU2n, as illustrated in FIG. 1, includes (i) the pixel electrode PE2n, (ii) the input transistor Mi2n, (iii) the output transistor Mo2n−1, and (iv) the capacitor Cb2n−1.

The input transistor Mi2n is a transistor that, in correspondence with the value of a gate potential applied to the gate bus line GLn, (i) permits an electric current to flow between the drain bus line DLm and the pixel electrode PE2n or (ii) blocks such an electric current therebetween. The input transistor Mi2n, as illustrated in FIG. 1, includes: a gate electrode connected to the gate bus line GLn; a drain electrode connected to the drain bus line DL; and a source electrode connected to the pixel electrode PE2n.

The capacitor Cb2n−1 includes: a capacitor electrode CE21n−1; and a capacitor electrode CE22n−1 provided to face the capacitor electrode CE21n−1 and connected to a storage capacitor bus line CLn−1.

The output transistor Mo2n−1 is a transistor that, in correspondence with the value of a gate potential applied to the gate bus line GLn−1, (i) permits an electric current to flow between the capacitor electrode CE21n−1 and the pixel electrode PE2n or (ii) blocks such an electric current therebetween. The output transistor Mo2n−1, as illustrated in FIG. 1, includes: a gate electrode connected to the gate bus line GLn−1; a drain electrode connected to the capacitor electrode CE21n−1; and a source electrode connected to the pixel electrode PE2n.

The pixel electrode PE2n and the common electrode 108 form a liquid crystal capacitor Clc2n therebetween.

(Operation of Liquid Crystal Display Device Circuit 1)

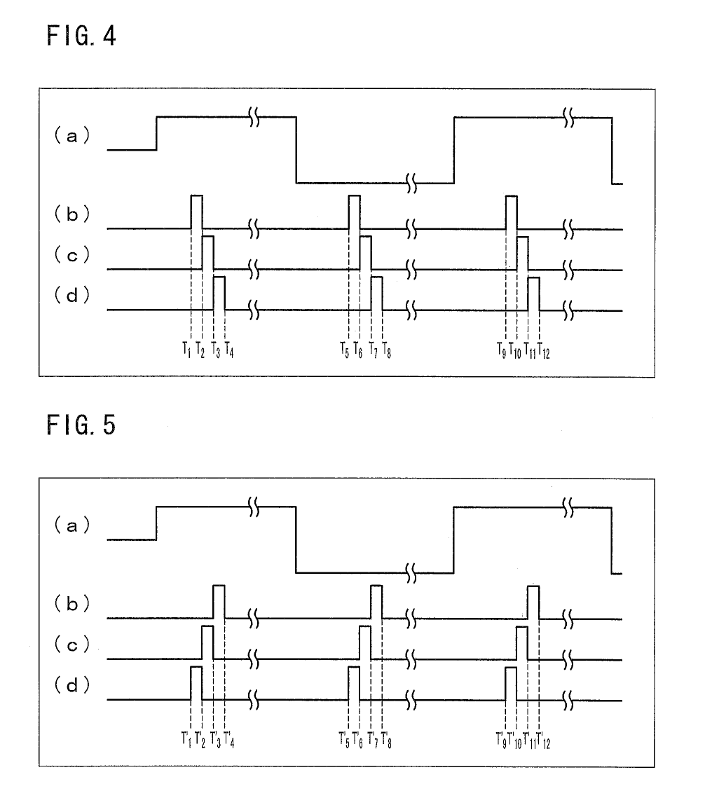

The following describes an operation of the liquid crystal display device circuit 1 with reference to FIGS. 4 through 6.

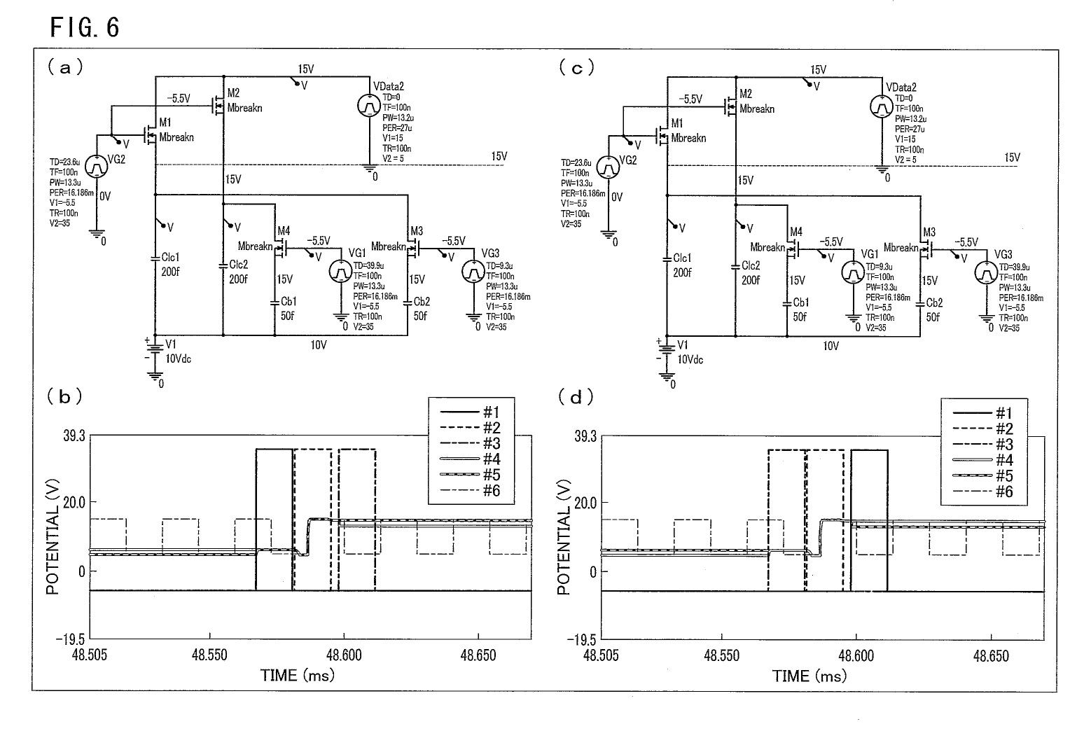

With reference to (a) through (d) of FIG. 4 and (a) and (b) of FIG. 6, the description below first deals with an operation of the liquid crystal display device circuit 1 for a case in which the scan direction is a forward direction. The case in which the scan direction is a forward direction refers to a case in which in a liquid crystal display device circuit 1 having a total of N gate bus lines, gate potentials are applied to the N gate bus lines sequentially from a gate bus line GL1 to a gate bus line GLN.

(a) of FIG. 4 illustrates a waveform of a data potential #DL applied by the drain bus line driving circuit 112 to the drain bus line DL. (b) of FIG. 4 illustrates a waveform of a gate potential #GLn−1 applied to the gate bus line GLn−1. (c) of FIG. 4 illustrates a waveform of a gate potential #GLn applied to the gate bus line GLn. (d) of FIG. 4 illustrates a waveform of a gate potential #GLn+1 applied to the gate bus line GLn+1.

The description below deals with an example case in which the data potential #DL is repeatedly switched between a high potential and a low potential through a predetermined cycle as illustrated in (a) of FIG. 4. (a) through (d) of FIG. 4 each indicate a time along its horizontal axis and a potential level along its vertical axis.

The description below deals with an operation of the liquid crystal display device circuit 1 by taking for example a case in which in an initial state, (i) none of the pixel electrode PE1n, the pixel electrode PE2n, the capacitor electrode CE11n+1, and the capacitor electrode CE21n−1 stores an electric charge, and (ii) the storage capacitor bus line CLn−1, the storage capacitor bus line CLn, the storage capacitor bus line CLn+1, and the common electrode 108 each have a potential of 0.

First, as illustrated in (a) through (d) of FIG. 4, during the period from a time T1 to a time T2, (i) the gate potential #GLn−1 is at a high level, so the output transistor Mo2n−1 is in a conductive state, whereas (ii) the gate potential #GLn is at a low level, so the input transistor Mi2n is in a non-conductive state.

This causes the pixel electrode PE2n and the capacitor electrode CE21n−1 to each store no electric charge during the period from the time T1 to the time T2.

Next, during the period from the time T2 to a time T3, (i) the gate potential #GLn is at a high level, so the input transistor Mi1n and the input transistor Mi2n are each in a conductive state, whereas (ii) the gate potential #GLn−1 and the gate potential #GLn+1 are each at a low level, so the output transistor Mo2n−1 and the output transistor Mo1n+1 are each in a non-conductive state.

This causes the data potential #DL applied to the drain bus line DL, the potential of the pixel electrode PE1n, and the potential of the pixel electrode PE2n to be equal to one another during the period from the time T2 to the time T3.

The pixel electrode PE1n stores an electric charge Q1=C1×V, whereas the pixel electrode PE2n stores an electric charge Q2=C2×V, where V represents the potential of the data potential #DL, C1 represents the capacitance of the pixel capacitor Clc1n, and C2 represents the capacitance of the pixel capacitor Clc2n. Further, V1=V and V2=V, where V1 represents the potential of the pixel electrode PE1n, and V2 represents the potential of the pixel electrode PE2n.

During the period from the time T3 to a time T4, (i) the gate potential #GLn+1 is at a high level, so the output transistor Mo1n+1 is in a conductive state, whereas (ii) the gate potential #GLn is at a low level, so the input transistor Mi1n is in a non-conductive state.

This causes the potential of the pixel electrode PE1n and the potential of the capacitor electrode CE11n+1 to be equal to each other during the period from the time T3 to the time T4. In other words, the sum of (i) the electric charge Q1 stored in the pixel electrode PE1n and (ii) the electric charge Qb1 stored in the capacitor electrode CE11n+1 is distributed between the pixel electrode PE1n and the capacitor electrode CE11n+1 so that the potential of the pixel electrode PE1n is equal to the potential of the capacitor electrode CE11n+1.

The potential V1 of the pixel electrode PE1n is now V1=C1×V/(C1+Cb1), where Cb1 represents the capacitance of the capacitor Cb1n+1, whereas the potential V2 of the pixel electrode PE2n remains V2=V. Further, the electric charge Qb1 stored in the capacitor electrode CE11n+1 is Qb1=Cb1×V1=Cb1×C1×V/(C1+Cb1).

This causes the potential difference between the pixel electrode PE1n and the common electrode 108 to be smaller than the potential difference between the pixel electrode PE2n and the common electrode 108 during the period from the time T3 to the time T4.

Next, during the period from the time T4 to a time T5, the gate potential #GLn−1, the gate potential #GLn, and the gate potential #GLn+1 are each 0. This causes the potential V1 of the pixel electrode PE1n and the potential V2 of the pixel electrode PE2n to be retained at the above respective values until the time T5.

Then, during the period from the time T5 to a time T6, the output transistor Mo2n−1 is in a conductive state, whereas the input transistor Mi2n is in a non-conductive state. This causes the electric charge Q2 stored in the pixel electrode PE2n to be distributed between the pixel electrode PE2n and the capacitor electrode CE21n−1 during the period from the time T5 to the time T6 so that the potential of the pixel electrode PE2n is equal to the potential of the capacitor electrode CE21n−1.

During the period from the time T6 to a time T7, the input transistor Mi1n and the input transistor Mi2n are each in a conductive state, whereas the output transistor Mo2n−1 and the output transistor Mo1n+1 are each in a non-conductive state. This causes the data potential #DL applied to the drain bus line DL, the potential of the pixel electrode PE1n, and the potential of the pixel electrode PE2n to be equal to one another during the period from the time T6 to the time T7.

Assuming that the potential of the data potential #DL is −V, (i) the electric charge Q1 stored in the pixel electrode PE1n is Q1=−C1×V, whereas the electric charge Q2 stored in the pixel electrode PE2n is Q2=−C2×V, and (ii) the potential V1 of the pixel electrode PE1n is V1=−V, whereas the potential V2 of the pixel electrode PE2n is V2=−V.

Next, during the period from the time T7 to a time T8, the output transistor Mo1n+1 is in a conductive state, whereas the input transistor Mi1n is in a non-conductive state. This causes the potential of the pixel electrode PE1n and the potential of the capacitor electrode CE11n+1 to be equal to each other during the period from the time T7 to the time T8. In other words, the sum of (i) the electric charge Q1 stored in the pixel electrode PE1n and (ii) the electric charge Qb1 stored in the capacitor electrode CE11n+1 is distributed between the pixel electrode PE1n and the capacitor electrode CE11n+1 so that the potential of the pixel electrode PE1n is equal to the potential of the capacitor electrode CE11n+1.

The sum of the electric charge Q1 and the electric charge Qb1 is Q1+Qb1=−C1²×V/(C1+Cb1), so the potential V1 of the pixel electrode PE1n is now V1=−C1²×V/(C1+Cb1)², whereas the potential V2 of the pixel electrode PE2n remains V2=−V.

This causes the potential difference between the pixel electrode PE1n and the common electrode 108 to be smaller than the potential difference between the pixel electrode PE2n and the common electrode 108 during the period from the time T7 to the time T8. The potential V1 of the pixel electrode PE1n and the potential V2 of the pixel electrode PE2n are retained at the above respective values until the time T9.

The liquid crystal display device circuit 1, as described above, includes: the capacitor Cb1n+1; and the transistor Mo1n+1 that switches, in correspondence with the gate potential #GLn+1 applied to the gate bus line GLn+1, between (i) a state in which an electric current flows between the pixel electrode PE1n and the capacitor electrode CE11n+1 and (ii) a state in which the pixel electrode PE1n and the capacitor electrode CE11n+1 are insulated from each other. This configuration allows the potential difference between the pixel electrode PE1n and the common electrode 108 to be smaller than the potential difference between the pixel electrode PE2n and the common electrode 108 in the case where the scan direction is a forward direction.

(a) and (b) of FIG. 6 illustrate results of simulating, on the basis of a SPICE (simulation program with integrated circuit emphasis), an operation of the liquid crystal display device circuit 1 for the case in which the scan direction is a forward direction. (a) of FIG. 6 shows a circuit configuration and parameter values used in the simulation. (b) of FIG. 6 illustrates the results of the simulation.

In (b) of FIG. 6, #1 represents a gate potential #GLn−1 used in the simulation, #2 represents a gate potential #GLn used in the simulation, #3 represents a gate potential #GLn+1 used in the simulation, #4 represents the potential V1 of a pixel electrode PE1n simulated, #5 represents the potential V2 of a pixel electrode PE2n simulated, and #6 represents a data potential #DL used in the simulation. This simulation set the potential of a common electrode 108 to 10.0 volts.

(b) of FIG. 6 clearly indicates that the potential difference between the pixel electrode PE1n and the common electrode is constantly smaller than the potential difference between the pixel electrode PE2n and the common electrode during (i) the period until the gate potential #GLn−1 rises and (ii) the period after the gate potential #GLn+1 has risen.

As described above, the liquid crystal display device circuit 1, in the case where the scan direction is a forward direction, allows a potential difference to be generated between the respective potentials applied to two pixel electrodes provided in each pixel region.

It is commonly known that it is possible to improve a viewing angle characteristic by including a plurality of pixels in each pixel region and applying different potentials to the respective pixels. Therefore, a liquid crystal display device including the liquid crystal display device circuit 1 can carry out a display having a good viewing angle characteristic in the case where the scan direction is a forward direction.

With reference to (a) through (d) of FIG. 5 and (c) and (d) of FIG. 6, the description below now deals with an operation of the liquid crystal display device circuit 1 for a case in which the scan direction is a backward direction. The case in which the scan direction is a backward direction refers to a case in which in a liquid crystal display device circuit 1 having a total of N gate bus lines, gate potentials are applied to the N gate bus lines sequentially from a gate bus line GLN to a gate bus line GL1.

(a) of FIG. 5 illustrates a waveform of a data potential #DL applied by the drain bus line driving circuit 112 to the drain bus line DL. (b) of FIG. 5 illustrates a waveform of a gate potential #GLn−1 applied to the gate bus line GLn−1. (c) of FIG. 5 illustrates a waveform of a gate potential #GLn applied to the gate bus line GLn. (d) of FIG. 5 illustrates a waveform of a gate potential #GLn+1 applied to the gate bus line GLn+1. (a) through (d) of FIG. 5 each indicate a time along its horizontal axis and a potential level along its vertical axis.

The operation of the liquid crystal display device circuit 1 for the case in which the scan direction is a backward direction is substantially identical to that for the case in which the scan direction is a forward direction, except that since the scan direction is a backward direction, the potential difference between the pixel electrode PE2n and the common electrode 108 is smaller than the potential difference between the pixel electrode PE1n and the common electrode 108.

For example, during the period from a time T3′ to a time T4′ in (a) through (d) of FIG. 5, the sum of (i) the electric charge Q2 stored in the pixel electrode PE2n and (ii) the electric charge Qb2 stored in the capacitor electrode CE21n−1 is distributed between the pixel electrode PE2n and the capacitor electrode CE21n+1 so that the potential of the pixel electrode PE2n is equal to the potential of the capacitor electrode CE21n−1. The potential of the pixel electrode PE2n, on the other hand, remains equal to the data potential #DL.

For the other periods, the above description for the case in which the scan direction is a forward direction can apply similarly.

The liquid crystal display device circuit 1, as described above, includes: the capacitor Cb2n−1; and the transistor Mo2n−1 that switches, in correspondence with the gate potential #GLn−1 applied to the gate bus line GLn−1, between (i) a state in which an electric current flows between the pixel electrode PE2n and the capacitor electrode CE21n−1 and (ii) a state in which the pixel electrode PE2n and the capacitor electrode CE21n−1 are insulated from each other. This configuration allows the potential difference between the pixel electrode PE2n and the common electrode 108 to be smaller than the potential difference between the pixel electrode PE1n and the common electrode 108 in the case where the scan direction is a backward direction.

(c) and (d) of FIG. 6 illustrate results of simulating, on the basis of a SPICE, an operation of the liquid crystal display device circuit 1 for the case in which the scan direction is a backward direction. (c) of FIG. 6 shows a circuit configuration and parameter values used in the simulation. (d) of FIG. 6 illustrates the results of the simulation.

In (d) of FIG. 6, #1 represents a gate potential #GLn−1 used in the simulation, #2 represents a gate potential #GLn used in the simulation, #3 represents a gate potential #GLn+1 used in the simulation, #4 represents the potential V1 of a pixel electrode PE1n simulated, #5 represents the potential V2 of a pixel electrode PE2n simulated, and #6 represents a data potential #DL used in the simulation. This simulation set the potential of a common electrode 108 to 10.0 volts.

(d) of FIG. 6 clearly indicates that the potential difference between the pixel electrode PE2n and the common electrode is constantly smaller than the potential difference between the pixel electrode PE1n and the common electrode during (i) the period until the gate potential #GLn+1 rises and (ii) the period after the gate potential #GLn−1 has risen.

As described above, the liquid crystal display device circuit 1, even in the case where the scan direction is a backward direction, allows a potential difference to be generated between the respective potentials applied to two pixel electrodes provided in each pixel region. Therefore, a liquid crystal display device including the liquid crystal display device circuit 1 can carry out a display having a good viewing angle characteristic even in the case where the scan direction is a backward direction.

A liquid crystal display device including the liquid crystal display device circuit 1 can carry out a display having a good viewing angle characteristic regardless of the scan direction.

The liquid crystal capacitor Clc1n and the storage capacitor Cb1n+1 preferably have a size ratio that is equal to the size ratio between the liquid crystal capacitor Clc2n and the storage capacitor Cb2n−1. In other words, the pixel electrode PE1n and the pixel electrode PE2n preferably have an area ratio that is equal to the size ratio between the storage capacitor Cb1n+1 and the storage capacitor Cb2n−1.

This configuration allows (i) the potential difference generated between the potential of the pixel electrode PE1n and the potential of the pixel electrode PE2n in the case where the scan direction is a backward direction to be equal to (ii) a potential difference generated between the potential of the pixel electrode PE1n and the potential of the pixel electrode PE2n in the case where the scan direction is a forward direction.

The above configuration thus makes it possible to achieve an equally good viewing angle characteristic regardless of whether the scan direction is a forward direction or a backward direction.

The above description deals with only a basic configuration of the liquid crystal display device circuit 1. The present invention is, however, not limited to such a basic configuration described above.

The basic configuration may be altered such that, for example, (i) a source electrode of the transistor Mi1n and the storage capacitor bus line CLn+1 form a storage capacitor therebetween, or that (ii) a source electrode of the transistor Mi2n and the storage capacitor bus line CLn−1 form a storage capacitor therebetween. Even such a configuration makes it possible to generate a potential difference between the potential of the pixel electrode PE2n and the potential of the pixel electrode PE1n.

In the above description, the output transistor Mo1n+1 has a gate electrode connected to the gate bus line GLn+1. The present invention is, however, not limited to such a configuration. Typically, an effect similar to the above can be achieved in the case where the output transistor Mo1n+1 has a gate electrode connected to a gate bus line GLp (p≧n+1) provided to be subsequent to the gate bus line GLn+1. Further, an effect similar to the above can be achieved in the case where the output transistor Mo2n−1 has a gate terminal connected to gate bus line GLq (q≦n−1) provided to precede the gate bus line GLn−1.

In the above description, the capacitor electrode CE12n+1 is connected to the storage capacitor bus line CLn+1. The present invention is, however, not limited to such a configuration. Typically, an effect similar to the above can be achieved even in the case where the capacitor electrode CE12n+1 is connected to a storage capacitor bus line CLr (r≠n+1) other than the storage capacitor bus line CLn+1. This applies also to the capacitor electrode CE22n−1.

The liquid crystal display device circuit 1 includes pixel regions each connected to three gate bus lines. It is clear from this configuration that, assuming that the total number of gate bus lines is N, the TFT substrate 10, in which the liquid crystal display device circuit 1 is provided, can include up to a total of N−2 pixel regions along a direction perpendicular to the gate bus lines.

In other words, assuming that the total number of pixel regions along the direction perpendicular to the gate bus lines is A, the liquid crystal display device circuit 1 of the present invention includes A+2 or more gate bus lines in total. For example, vertical resolutions of 720 lines, 768 lines, 800 lines, and 1080 lines correspond respectively to 722 or more gate bus lines, 770 or more gate bus lines, 802 or more gate bus lines, and 1082 or more gate bus lines included in the liquid crystal display device circuit 1 of the present invention.

<Variation>

In the above description, the TFT substrate 10 includes two pixel electrodes in each of the individual pixel regions defined by the gate bus lines and the drain bus lines. The present invention is, however, not limited to such a configuration.

Typically, in a case where there are provided more pixel electrodes in each pixel region such that there is a potential difference among respective potentials of the pixel electrodes, it is possible to further improve the viewing angle characteristic.

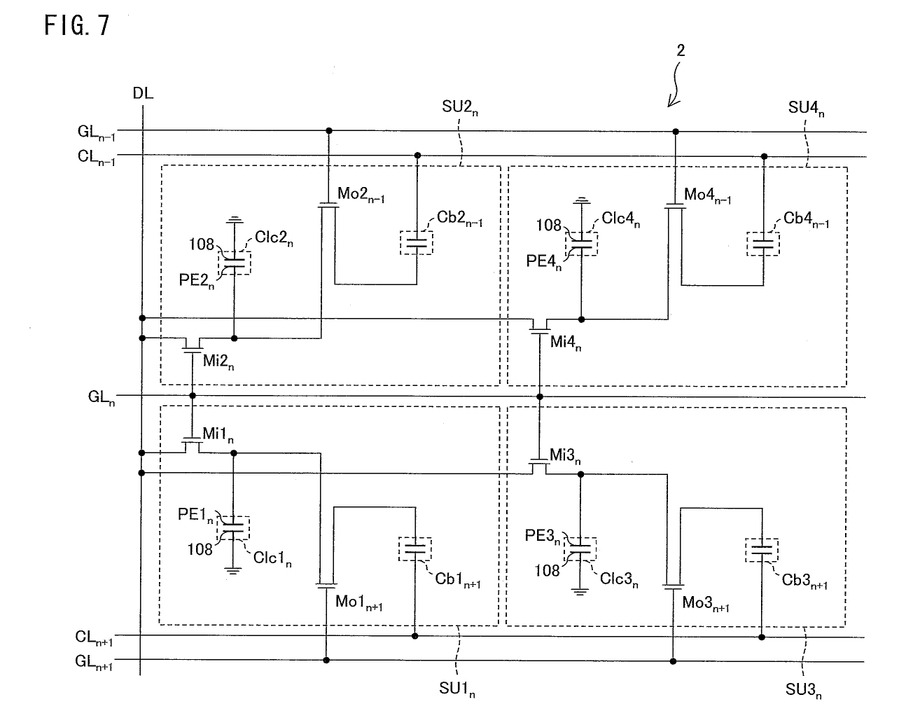

The following describes, with reference to FIG. 7, a liquid crystal display device circuit 2 provided in a TFT substrate including four pixel electrodes in each of the individual pixel regions defined by the gate bus lines and the drain bus lines. More specifically the following describes, with reference to FIG. 7, a liquid crystal display device circuit 2 including not only the pixel electrode PE1n and the pixel electrode PE2n described above, but also a pixel electrode PE3n and a pixel electrode PE4n.

FIG. 7 is a circuit diagram illustrating a configuration of the liquid crystal display device circuit 2 of the present variation. The liquid crystal display device circuit 2, as illustrated in FIG. 7, further includes: a sub-unit SU3n similar to the sub-unit SU1n; and a sub-unit SU4n similar to the sub-unit SU2n, in addition to the configuration of the liquid crystal display device circuit 1.

The sub-unit SU3n supplies an electric charge from the drain bus line DL to the pixel electrode PE3n in correspondence with the value of a potential applied to the gate bus line GLn. Further, the sub-unit SU3n decreases the potential difference between the potential of the pixel electrode PE3n and the potential of the common electrode 108 in correspondence with the value of a potential applied to the gate bus line GLn+1.

The sub-unit SU4n supplies an electric charge from the drain bus line DL to the pixel electrode PE4n in correspondence with the value of a potential applied to the gate bus line GLn. Further, the sub-unit SU4n decreases the potential difference between the potential of the pixel electrode PE4n and the potential of the common electrode 108 in correspondence with the value of a potential applied to the gate bus line GLn+1.

The respective detailed operations of the sub-unit SU3n and the sub-unit SU4n are similar to those of the sub-unit SU1n and the sub-unit SU2n, respectively.

The liquid crystal display device circuit 2, in the case where the scan direction is a forward direction, both (i) causes the potential difference between the pixel electrode PE1n and the common electrode 108 to be smaller than the potential difference between the pixel electrode PE2n and the common electrode 108 and (ii) causes the potential difference between the pixel electrode PE3n and the common electrode 108 to be smaller than the potential difference between the pixel electrode PE4n and the common electrode 108.

Further, the liquid crystal display device circuit 2, in the case where the scan direction is a backward direction, both (i) causes the potential difference between the pixel electrode PE2n and the common electrode 108 to be smaller than the potential difference between the pixel electrode PE1n and the common electrode 108 and (ii) causes the potential difference between the pixel electrode PE4n and the common electrode 108 to be smaller than the potential difference between the pixel electrode PE3n and the common electrode 108.

As described above, the liquid crystal display device circuit 2, regardless of whether the scan direction is a forward direction or a backward direction, allows a potential difference to be generated between the respective potentials applied to four pixel electrodes provided in each pixel region. Therefore, a liquid crystal display device including the liquid crystal display device circuit 2 can carry out a display having a better viewing angle characteristic regardless of the scan direction.

As is clear from the above variation, the liquid crystal display device circuit of the present embodiment can typically be used also in a case where there are provided a random even number of pixel electrodes in each pixel region.

### Embodiment 2

As described above, the liquid crystal display device circuit 1 is configured such that (i) the sub-unit SU1n decreases the potential difference between the potential of the pixel electrode PE1n and the potential of the common electrode 108 in correspondence with the value of a potential applied to the gate bus line GLn+1, and that (ii) the sub-unit SU2n decreases the potential difference between the potential of the pixel electrode PE2n and the potential of the common electrode 108 in correspondence with the value of a potential applied to the gate bus line GLn−1. In other words, the liquid crystal display device circuit 1 is configured such that the different scan directions result in different pixel electrodes having a decreased potential difference with respect to the common electrode 108.

This indicates that in the liquid crystal display device circuit 1, the potential difference generated between the pixel electrode PE1n and the pixel electrode PE2n in the case where the scan direction is a forward direction may, depending on the respective sizes of the liquid crystal capacitor Clc1n, the storage capacitor Cb1n+1, the liquid crystal capacitor Clc2n, and the storage capacitor Cb2n−1, be different from the potential difference generated between the pixel electrode PE1n and the pixel electrode PE2n in the case where the scan direction is a forward direction.

Those potential differences being different from each other give rise to a secondary problem of a viewing angle characteristic varying according to the scan direction.

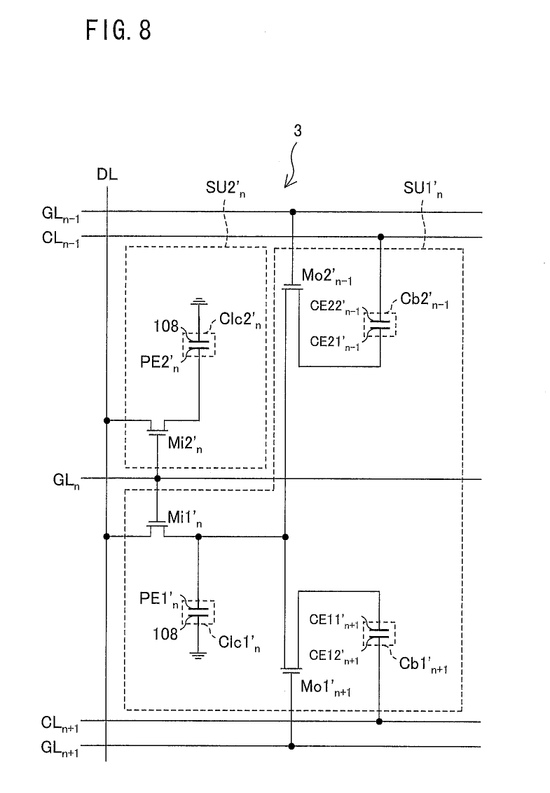

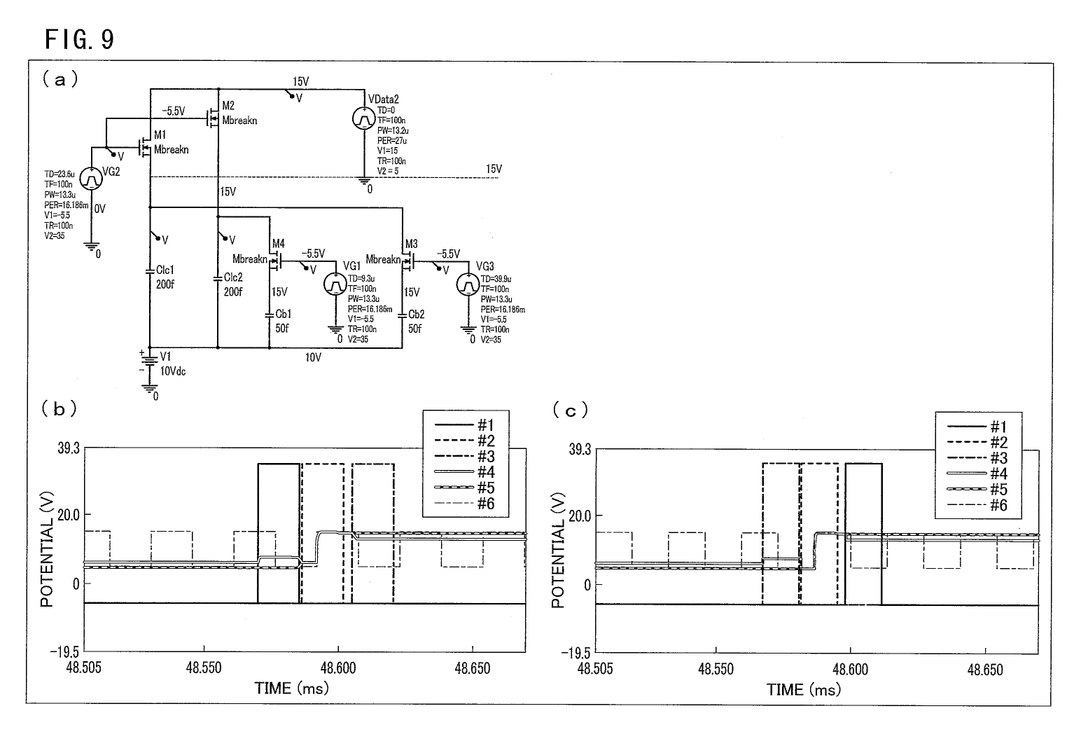

The following describes, with reference to FIG. 8 and (a) through (c) of FIG. 9, a liquid crystal display device circuit 3 in which a pixel electrode that generates, with respect to the common electrode 108, a potential difference which is decreased in the case where the scan direction is a forward direction is identical to a pixel electrode that generates, with respect to the common electrode 108, a potential difference which is decreased in the case where the scan direction is a backward direction.

FIG. 8 is a circuit diagram illustrating a configuration of the liquid crystal display device circuit 3 of the present embodiment. The liquid crystal display device circuit 3, as illustrated in FIG. 8, includes a sub-unit SU1n′ and a sub-unit SU2n′.

The sub-unit SU1n′ supplies an electric charge from the drain bus line DL to the pixel electrode PE1n′ in correspondence with the value of a potential applied to the gate bus line GLn. Further, the sub-unit SU1n′ decreases the potential difference between the potential of the pixel electrode PE1n′ and the potential of the common electrode 108 in correspondence with the respective values of potentials applied to the gate bus line GLn+1 and the gate bus line GLn−1.

The sub-unit SU1n′, as illustrated in FIG. 8, includes: a pixel electrode PE1n′; an input transistor Mi1n′; an output transistor Mo1n+1′; an output transistor Mo2n−1′; a capacitor Cb1n+1′; and a capacitor Cb2n−1′.

The pixel electrode PE1n′, the input transistor Mi1n′, the output transistor Mo1n+1′, the capacitor Cb1n+1′, and the capacitor Cb2n−1′ are similar in configuration to the pixel electrode PE1n, the input transistor Mi1n, the output transistor Mo1n+1, the capacitor Cb1n+1, and the capacitor Cb2n−1, respectively.

The output transistor Mo2n−1′ is a transistor that, in correspondence with the value of a gate potential applied to the gate bus line GLn−1, (i) permits an electric current to flow between the capacitor electrode CE21n−1′ and the pixel electrode PE1n′ or (ii) blocks such an electric current therebetween. The output transistor Mo2n−1′, as illustrated in FIG. 8, includes: a gate electrode connected to the gate bus line GLn-1; a drain electrode connected to the capacitor electrode CE21n−1′; and a source electrode connected to the pixel electrode PE1n′.

The pixel electrode PE1n′ and the common electrode 108 form a liquid crystal capacitor Clc1n′ therebetween.

The sub-unit SU2n′ supplies an electric charge from the drain bus line DL to the pixel electrode PE2n′ in correspondence with the value of a potential applied to the gate bus line GLn.

The pixel electrode PE2n′ and the common electrode 108 form a liquid crystal capacitor Clc2n′ therebetween.

The operation of the liquid crystal display device circuit 3 is substantially identical to that of the liquid crystal display device circuit 1 described in Embodiment 1, but is different from it on the point below.

The liquid crystal display device circuit 1 is configured such that in the case where the scan direction is a backward direction, the output transistor Mo2n−1 is switched to a conductive state so that the potential difference between the potential of the pixel electrode PE2n and the potential of the common electrode 108 is decreased. The liquid crystal display device circuit 3 is, in contrast, configured such that in the case where the scan direction is a backward direction, the output transistor Mo2n−1′ is switched to a conductive state so that the potential difference between the potential of the pixel electrode PE1n′ and the potential of the common electrode 108 is decreased.

Further, the liquid crystal display device circuit 3 is configured such that the potential difference between the pixel electrode PE2n′ and the common electrode 108 is not decreased regardless of whether the scan direction is a forward direction or a backward direction.

Therefore, the liquid crystal display device circuit 3 can cause the potential difference between the pixel electrode PE1n′ and the common electrode 108 to be smaller than the potential difference between the pixel electrode PE2n′ and the common electrode 108 regardless of the scan direction.

(a) through (c) of FIG. 9 illustrate the results of simulating an operation of the liquid crystal display device circuit 3 on the basis of a SPICE. (a) of FIG. 9 shows a circuit configuration and parameter values used in the simulation. (b) of FIG. 9 illustrates the results of the simulation for the case in which the scan direction is a forward direction. (c) of FIG. 9 illustrates the results of the simulation for the case in which the scan direction is a backward direction.

In (b) and (c) of FIG. 9, #1 represents a gate potential #GLn−1 used in the simulation, #2 represents a gate potential #GLn used in the simulation, #3 represents a gate potential #GLn+1 used in the simulation, #4 represents the potential V1 of a pixel electrode PE1n simulated, #5 represents the potential V2 of a pixel electrode PE2n simulated, and #6 represents a data potential #DL used in the simulation. This simulation set the potential of a common electrode 108 to 10.0 V.

(b) of FIG. 9 clearly indicates that in the case where the scan direction is a forward direction, the potential difference between the pixel electrode PE1n′ and the common electrode is constantly smaller than the potential difference between the pixel electrode PE2n′ and the common electrode during (i) the period until the gate potential #GLn−1 falls and (ii) the period after the gate potential #GLn+1 has risen.

Further, (c) of FIG. 9 clearly indicates that in the case where the scan direction is a backward direction, the potential difference between the pixel electrode PE1n′ and the common electrode is constantly smaller than the potential difference between the pixel electrode PE2n′ and the common electrode during (i) the period until the gate potential #GLn+1 falls and (ii) the period after the gate potential #GLn−1 has risen.

This indicates that the liquid crystal display device circuit 3 is configured such that a pixel electrode that generates, with respect to the common electrode 108, a potential difference which is decreased in the case where the scan direction is a forward direction is identical to a pixel electrode that generates, with respect to the common electrode 108, a potential difference which is decreased in the case where the scan direction is a backward direction.

The liquid crystal display device circuit 3 is preferably configured such that the storage capacitor Cb1n+1′ is equal in size to the storage capacitor Cb2n−1′. This configuration makes it possible to achieve an equally good viewing angle characteristic regardless of whether the scan direction is a forward direction or a backward direction.

<Variation>

In the above description, the liquid crystal display device circuit 3 includes two pixel electrodes in each pixel region. The present invention is, however, not limited to such a configuration.

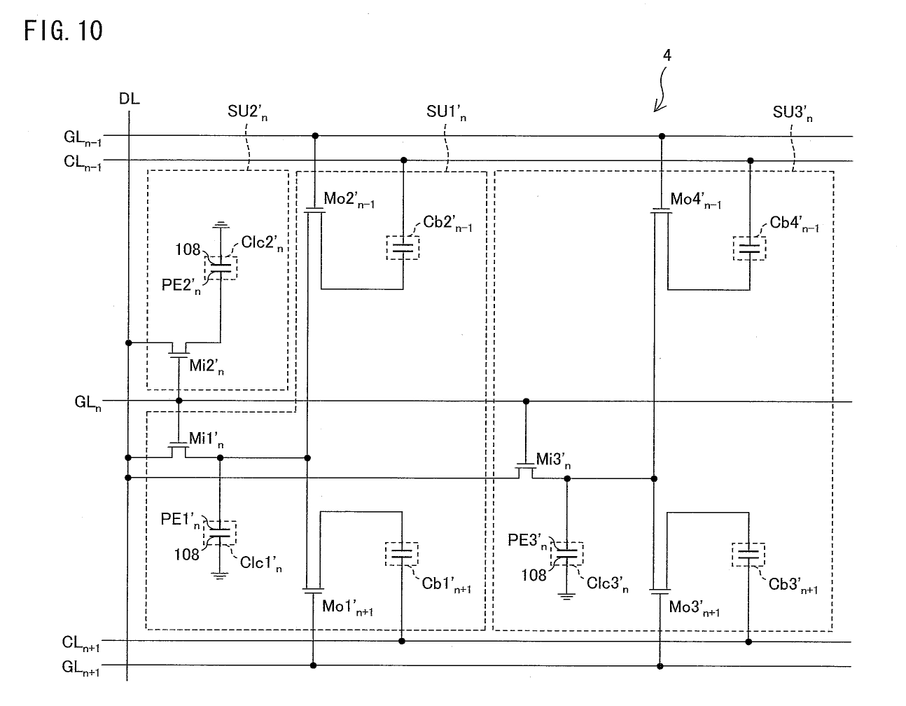

The following describes, with reference to FIG. 10, a liquid crystal display device circuit 4 including three pixel electrodes in each pixel region. More specifically, the following describes a liquid crystal display device circuit 4 that includes not only the pixel electrode PE1n′ and the pixel electrode PE2n′ described above, but also a pixel electrode PE3n′.

FIG. 10 is a circuit diagram illustrating a configuration of the liquid crystal display device circuit 4 of the present variation. The liquid crystal display device circuit 4, as illustrated in FIG. 10, further includes a sub-unit SU3n′ similar to the sub-unit SU1n′, in addition to the configuration of the liquid crystal display device circuit 3.

The sub-unit SU3n′ supplies an electric charge from the drain bus line DL to the pixel electrode PE3n′ in correspondence with the value of a potential applied to the gate bus line GLn. Further, the sub-unit SU3n′ decreases the potential difference between the potential of the pixel electrode PE3n′ and the potential of the common electrode 108 in correspondence with the respective values of potentials applied to the gate bus line GLn+1 and the gate bus line GLn−1.

The detailed operation of the sub-unit SU3n′ is similar to that of the sub-unit SU1n′.

Therefore, the liquid crystal display device circuit 4 can, regardless of the scan direction, both (i) cause the potential difference between the pixel electrode PE1n′ and the common electrode 108 to be smaller than the potential difference between the pixel electrode PE2n′ and the common electrode 108, and (ii) cause the potential difference between the pixel electrode PE3n′ and the common electrode 108 to be smaller than the potential difference between the pixel electrode PE2n′ and the common electrode 108.

As described above, the liquid crystal display device circuit 4, regardless of the scan direction, allows a potential difference to be generated between the respective potentials applied to three pixel electrodes provided in each pixel region. Further, a pixel electrode that generates, with respect to the common electrode 108, a potential difference which is decreased in the case where the scan direction is a forward direction is identical to a pixel electrode that generates, with respect to the common electrode 108, a potential difference which is decreased in the case where the scan direction is a backward direction.

Therefore, a liquid crystal display device including the liquid crystal display device circuit 4 has a better viewing angle characteristic that does not vary with a variation of the scan direction.

As is clear from the above variation, the liquid crystal display device circuit of the present embodiment can be used also in a case where there are provided a random number of pixel electrodes in each pixel region which number is two or more.

(Supplemental Notes)

As described above, the liquid crystal display device circuit 1 and the liquid crystal display device circuit 2 of Embodiment 1 and the liquid crystal display device circuit 3 and the liquid crystal display device circuit 4 of Embodiment 2 can each reduce power consumption and have a good viewing angle characteristic regardless of whether the scan direction is a forward direction or a backward direction.

Since setting the scan direction to a backward direction can, as described below, reduce a period necessary to display a single frame as compared to a case in which the scan direction is a forward direction, the liquid crystal display device circuits 1 through 4 can thus be suitably used for, e.g., a field sequential 3D display, in which an image for the right eye and an image for the left eye are alternately displayed so that a three-dimensional video image is displayed. Assuming that a liquid crystal display device board includes N pixels and applies data voltages to the pixels sequentially from the first pixel, the above period necessary to display a single frame refers to a period from (i) a moment at which liquid crystal included in the first pixel of the liquid crystal display device board starts its response to (ii) a moment at which liquid crystal included in the N-th pixel ends its response.

First, Tdis=Tscan+Tres, where Tdis represents a period necessary to display a single frame, Tscan represents a period from (i) a moment at which a data voltage is applied to liquid crystal included in the first pixel to (ii) a moment at which a data voltage is applied to liquid crystal included in the N-th pixel, and (iii) Tres represents a response time of liquid crystal included in each pixel (that is, a period from (i) a moment at which a voltage is applied to the liquid crystal to (ii) a moment at which the liquid crystal ends its alignment change). In other words, the period Tdis necessary to display a single frame refers to a period from (i) a moment at which a data voltage is applied to liquid crystal included in the first pixel to (ii) a moment at which liquid crystal included in the last pixel ends its response. Further, viscosity of liquid crystal is temperature-dependent. Thus, a higher temperature typically results in a shorter response time.

At an upper portion of a liquid crystal display device, air that has been warmed by a backlight is stagnated. This tends to cause such an upper portion of a liquid crystal display device to have a higher temperature than a lower portion thereof. Thus, a backward scan (that is, a scan from a lower portion to an upper portion) causes a data voltage to be applied last to liquid crystal of a pixel having a high temperature (that is, liquid crystal with a small Tres value). This arrangement consequently reduces the period necessary to display a single frame as compared to a forward scan.

A liquid crystal display device board including any of the liquid crystal display device circuits 1 through 4 can, (i) by setting the scan direction to a backward direction as described above, reduce the period necessary to display a single frame and (ii) have a good viewing angle characteristic. The liquid crystal display device board can thus be suitably used in a liquid crystal display device that requires a high frame rate. The liquid crystal display device board can be suitably used in, for example, the above-mentioned 3D display and a liquid crystal display device that carries out a double-rate display.

(Recap)

As described above, a liquid crystal display device circuit of the present invention includes: a plurality of gate bus lines; a plurality of drain bus lines provided so as to be electrically separated from the plurality of gate bus lines and cross the plurality of gate bus lines; a plurality of storage capacitor bus lines provided in parallel to the plurality of gate bus lines; and in a pixel region defined by an n-th gate bus line among the plurality of gate bus lines and an m-th drain bus line among the plurality of gate bus lines, (i) at least one first sub-unit and (ii) a second sub-unit present in a number equal to a number of the at least one first sub-unit, the at least one first sub-unit including: a first pixel electrode; a first input transistor having (i) a gate electrode connected to the n-th gate bus line, (ii) a drain electrode connected to the m-th drain bus line, and (iii) a source electrode connected to the first pixel electrode; a first capacitor having a first end connected to a storage capacitor bus line among the plurality of storage capacitor bus lines; and a first output transistor having (i) a gate electrode connected to either a (n+1)th gate bus line or a gate bus line subsequent to the (n+1)th gate bus line among the plurality of gate bus lines, (ii) a drain electrode connected to a second end of the first capacitor, and (iii) a source electrode connected to the first pixel electrode, the second sub-unit including: a second pixel electrode; a second input transistor having (i) a gate electrode connected to the n-th gate bus line, (ii) a drain electrode connected to the m-th drain bus line, and (iii) a source electrode connected to the second pixel electrode; a second capacitor having a first end connected to a storage capacitor bus line among the plurality of storage capacitor bus lines; and a second output transistor having (i) a gate electrode connected to either an (n−1)th gate bus line or a gate bus line preceding the (n−1)th gate bus line among the plurality of gate bus lines, (ii) a drain electrode connected to a second end of the second capacitor, and (iii) a source electrode connected to the second pixel electrode.

In the above-arranged liquid crystal display device circuit of the present invention, a gate signal supplied to the n-th gate bus line sets the first input transistor and the second input transistor to a conductive state, which causes an electric charge to be supplied from the m-th drain bus line to the first pixel electrode and the second pixel electrode. This in turn causes both the potential of the first pixel electrode and the potential of the second pixel electrode to be equal to the potential of the drain bus line.

In the case where the scan direction is a forward direction, gate signals are then sequentially supplied to the (n+1)th gate bus line and its subsequent gate bus lines among the plurality of gate bus lines. This sets the first output transistor to a conductive state, which causes the electric charge stored in the first pixel electrode to be dispersed to the first capacitor, thus decreasing the potential of the first pixel electrode. The potential of the second pixel electrode, on the other hand, remains unchanged. This operation consequently causes a potential difference to be generated between the potential of the first pixel electrode and the potential of the second pixel electrode.

In the case where the scan direction is a backward direction, after a gate signal is supplied to the n-th gate bus line, gate signals are sequentially supplied to the (n−1)th gate bus line and its subsequent gate bus lines among the plurality of gate bus lines. This sets the second output transistor to a conductive state, which causes the electric charge stored in the second pixel electrode to be dispersed to the second capacitor, thus decreasing the potential of the second pixel electrode. The potential of the first pixel electrode, on the other hand, remains unchanged. This operation consequently causes a potential difference to be generated between the potential of the first pixel electrode and the potential of the second pixel electrode.

The above-arranged liquid crystal display device circuit, as described above, can cause a potential difference to be generated between the potential of the first pixel electrode and the potential of the second pixel electrode regardless of whether the scan direction is a forward direction or a backward direction.

Further, the above-arranged liquid crystal display device circuit can cause a potential difference to be generated between the potential of the first pixel electrode and the potential of the second pixel electrode without changing the potential of a storage capacitor bus line.

It is known that generating a potential difference between respective potentials of adjacent pixels can improve a viewing angle characteristic.

Thus, the above-arranged liquid crystal display device circuit can both reduce power consumption and have a good viewing angle characteristic regardless of whether the scan direction is a forward direction or a backward direction.

A liquid crystal display device circuit of the present invention includes: a plurality of gate bus lines; a plurality of drain bus lines provided so as to be electrically separated from the plurality of gate bus lines and cross the plurality of gate bus lines; a plurality of storage capacitor bus lines provided in parallel to the plurality of gate bus lines; and in a pixel region defined by an n-th gate bus line among the plurality of gate bus lines and an m-th gate bus line among the plurality of drain bus lines, (i) at least one first sub-unit and (ii) at least one second sub-unit, the at least one first sub-unit including: a first pixel electrode; a first input transistor having (i) a gate electrode connected to the n-th gate bus line, (ii) a drain electrode connected to the m-th drain bus line, and (iii) a source electrode connected to the first pixel electrode; a first capacitor having a first end connected to a storage capacitor bus line among the plurality of storage capacitor bus lines; a first output transistor having (i) a gate electrode connected to either a (n+1)th gate bus line or a gate bus line subsequent to the (n+1)th gate bus line among the plurality of gate bus lines, (ii) a drain electrode connected to a second end of the first capacitor, and (iii) a source electrode connected to the first pixel electrode; a second capacitor having a first end connected to a storage capacitor bus line among the plurality of storage capacitor bus lines; and a second output transistor having (i) a gate electrode connected to either an (n−1)th gate bus line or a gate bus line preceding the (n−1)th gate bus line among the plurality of gate bus lines, (ii) a drain electrode connected to a second end of the second capacitor, and (iii) a source electrode connected to the first pixel electrode, the at least one second sub-unit including: a second pixel electrode; and a second input transistor having (i) a gate electrode connected to the n-th gate bus line, (ii) a drain electrode connected to the m-th drain bus line, and (iii) a source electrode connected to the second pixel electrode.

In the above-arranged liquid crystal display device circuit of the present invention, a gate signal supplied to the n-th gate bus line sets the first input transistor and the second input transistor to a conductive state, which causes an electric charge to be supplied from the m-th drain bus line to the first pixel electrode and the second pixel electrode. This in turn causes both the potential of the first pixel electrode and the potential of the second pixel electrode to be equal to the potential of the drain bus line.

In the case where the scan direction is a forward direction, gate signals are then sequentially supplied to the (n+1)th gate bus line and its subsequent gate bus lines among the plurality of gate bus lines. This sets the first output transistor to a conductive state, which causes the electric charge stored in the first pixel electrode to be dispersed to the first capacitor, thus decreasing the potential of the first pixel electrode. The potential of the second pixel electrode, on the other hand, remains unchanged. This operation consequently causes a potential difference to be generated between the potential of the first pixel electrode and the potential of the second pixel electrode.

In the case where the scan direction is a backward direction, after a gate signal is supplied to the n-th gate bus line, gate signals are sequentially supplied to the (n−1)th gate bus line and its subsequent gate bus lines among the plurality of gate bus lines. This sets the second output transistor to a conductive state, which causes the electric charge stored in the first pixel electrode to be dispersed to the second capacitor, thus decreasing the potential of the first pixel electrode. The potential of the second pixel electrode, on the other hand, remains unchanged. This operation consequently causes a potential difference to be generated between the potential of the first pixel electrode and the potential of the second pixel electrode.

It is commonly known that to achieve an optimal view characteristic, the area of the first pixel electrode and the area of the second pixel electrode desirably have an area ratio of 1:1.5 to 1:3. Further, to retain a gamma characteristic along a front direction and a view characteristic, (i) the area of the first pixel electrode and the area of the second pixel electrode preferably have an area ratio that is unchanged regardless of a change in the scan direction, and (ii) the larger one of the area of the first pixel electrode and the area of the second pixel electrode preferably remains as such regardless of a change in the scan direction. In addition, to retain the above characteristics, (i) the potential of the first pixel electrode and the potential of the second pixel electrode desirably have a potential difference that is unchanged regardless of a change in the scan direction, and (ii) the higher one of the potential of the first pixel electrode and the potential of the second pixel electrode desirably remains as such regardless of a change in the scan direction.

The above-arranged liquid crystal display device circuit can cause a potential difference to be generated between the potential of the first pixel electrode and the potential of the second pixel electrode regardless of whether the scan direction is a forward direction or a backward direction.

The above configuration allows (i) the area of the first pixel electrode and the area of the second pixel electrode to have an area ratio that is unchanged even if the scan direction is switched and (ii) the larger one of the area of the first pixel electrode and the area of the second pixel electrode to remain as such even if the scan direction is switched. Further, the above configuration allows (i) the potential of the first pixel electrode and the potential of the second pixel electrode to have a potential difference that is unchanged even if the scan direction is switched and (ii) the higher one of the potential of the first pixel electrode and the potential of the second pixel electrode to remain as such even if the scan direction is switched.

The above configuration thus can retain a gamma characteristic along a front direction and a view characteristic even if the scan direction is switched.

Further, the above-arranged liquid crystal display device circuit can cause a potential difference to be generated between the potential of the first pixel electrode and the potential of the second pixel electrode without changing the potential of a storage capacitor bus line.

Thus, the above-arranged liquid crystal display device circuit can both reduce power consumption and have a good viewing angle characteristic regardless of whether the scan direction is a forward direction or a backward direction.

The liquid crystal display device circuit may preferably be arranged such that an area ratio between the first pixel electrode and the second pixel electrode is equal to a capacitance ratio between the first capacitor and the second capacitor.

The above arrangement allows (i) a potential difference generated between the potential of the first pixel electrode and the potential of the second pixel electrode in the case where the scan direction is a forward direction to be equal to (ii) a potential difference generated between the potential of the first pixel electrode and the potential of the second pixel electrode in the case where the scan direction is a backward direction.

The above arrangement thus can further achieve an equally good viewing angle characteristic regardless of whether the scan direction is a forward direction or a backward direction.

The liquid crystal display device circuit may preferably be arranged such that a capacitance of the first capacitor is equal to a capacitance of the second capacitor.

The above arrangement allows (i) a potential difference generated between the potential of the first pixel electrode and the potential of the second pixel electrode in the case where the scan direction is a forward direction to be equal to (ii) a potential difference generated between the potential of the first pixel electrode and the potential of the second pixel electrode in the case where the scan direction is a backward direction.

The above arrangement thus can further achieve an equally good viewing angle characteristic regardless of whether the scan direction is a forward direction or a backward direction.

The liquid crystal display device circuit may preferably be arranged such that the first end of the first capacitor is connected to an (n+1)th storage capacitor bus line among the plurality of storage capacitor bus lines; the gate electrode of the first output transistor is connected to the (n+1)th gate bus line among the plurality of gate bus lines; the first end of the second capacitor is connected to an (n−1)th storage capacitor bus line among the plurality of storage capacitor bus lines; and the gate electrode of the second output transistor is connected to the (n-1)th gate bus line among the plurality of gate bus lines.

The above arrangement further allows a liquid crystal display device circuit of the present invention to be produced with use of the simplest circuit wiring.

The present invention encompasses in scope (i) a liquid crystal display device board including the liquid crystal display device circuit and (ii) a liquid crystal display device including the liquid crystal display device board.

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

### INDUSTRIAL APPLICABILITY

The present invention is suitably applicable to a liquid crystal display device board and a liquid crystal display device circuit provided in a liquid crystal display device board.

### REFERENCE SIGNS LIST

1 liquid crystal display device circuit

10 TFT substrate (liquid crystal display device board)

100 liquid crystal display device

108 common electrode

DLm drain bus line

GLn gate bus line

CLn storage capacitor bus line

SU1n sub-unit (first sub-unit)

SU2n sub-unit (second sub-unit)

PE1n pixel electrode (first pixel electrode)

PE2n pixel electrode (second pixel electrode)

Mi1n input transistor (first input transistor)

Mi2n input transistor (second input transistor)

Mo1n+1 output transistor (first output transistor)

Mo2n−1 output transistor (second output transistor)

Cb1n+1 capacitor (first capacitor)

Cb2n−1 capacitor (second capacitor)

1. A liquid crystal display device circuit comprising:
a plurality of gate bus lines;
a plurality of drain bus lines provided so as to be electrically separated from the plurality of gate bus lines and cross the plurality of gate bus lines;
a plurality of storage capacitor bus lines provided in parallel to the plurality of gate bus lines; and
in a pixel region defined by an n-th gate bus line among the plurality of gate bus lines and an m-th drain bus line among the plurality of drain bus lines, (i) at least one first sub-unit and (ii) a second sub-unit present in a number equal to a number of the at least one first sub-unit,
the at least one first sub-unit including:
a first pixel electrode;
a first input transistor having (i) a gate electrode connected to the n-th gate bus line, (ii) a drain electrode connected to the m-th drain bus line, and (iii) a source electrode connected to the first pixel electrode;
a first capacitor having a first end connected to a storage capacitor bus line among the plurality of storage capacitor bus lines; and
a first output transistor having (i) a gate electrode connected to either a (n+1)th gate bus line or a gate bus line subsequent to the (n+1)th gate bus line among the plurality of gate bus lines, (ii) a drain electrode connected to a second end of the first capacitor, and (iii) a source electrode connected to the first pixel electrode,
the second sub-unit including:
a second pixel electrode;
a second input transistor having (i) a gate electrode connected to the n-th gate bus line, (ii) a drain electrode connected to the m-th drain bus line, and (iii) a source electrode connected to the second pixel electrode;
a second capacitor having a first end connected to a storage capacitor bus line among the plurality of storage capacitor bus lines; and
a second output transistor having (i) a gate electrode connected to either an (n−1)th gate bus line or a gate bus line preceding the (n−1)th gate bus line among the plurality of gate bus lines, (ii) a drain electrode connected to a second end of the second capacitor, and (iii) a source electrode connected to the second pixel electrode.

2. A liquid crystal display device circuit comprising:
a plurality of gate bus lines;
a plurality of drain bus lines provided so as to be electrically separated from the plurality of gate bus lines and cross the plurality of gate bus lines;
a plurality of storage capacitor bus lines provided in parallel to the plurality of gate bus lines; and
in a pixel region defined by an n-th gate bus line among the plurality of gate bus lines and an m-th drain bus line among the plurality of drain bus lines, (i) at least one first sub-unit and (ii) at least one second sub-unit,
the at least one first sub-unit including:
a first pixel electrode;
a first input transistor having (i) a gate electrode connected to the n-th gate bus line, (ii) a drain electrode connected to the m-th drain bus line, and (iii) a source electrode connected to the first pixel electrode;
a first capacitor having a first end connected to a storage capacitor bus line among the plurality of storage capacitor bus lines;
a first output transistor having (i) a gate electrode connected to either a (n+1)th gate bus line or a gate bus line subsequent to the (n+1)th gate bus line among the plurality of gate bus lines, (ii) a drain electrode connected to a second end of the first capacitor, and (iii) a source electrode connected to the first pixel electrode;
a second capacitor having a first end connected to a storage capacitor bus line among the plurality of storage capacitor bus lines; and
a second output transistor having (i) a gate electrode connected to either an (n−1)th gate bus line or a gate bus line preceding the (n−1)th gate bus line among the plurality of gate bus lines, (ii) a drain electrode connected to a second end of the second capacitor, and (iii) a source electrode connected to the first pixel electrode,
the at least one second sub-unit including:
a second pixel electrode; and
a second input transistor having (i) a gate electrode connected to the n-th gate bus line, (ii) a drain electrode connected to the m-th drain bus line, and (iii) a source electrode connected to the second pixel electrode.

3. The liquid crystal display device circuit according to claim 1, wherein:
an area ratio between the first pixel electrode and the second pixel electrode is equal to a capacitance ratio between the first capacitor and the second capacitor.

4. The liquid crystal display device circuit according to claim 2, wherein:
a capacitance of the first capacitor is equal to a capacitance of the second capacitor.

5. The liquid crystal display device circuit according to claim 1,
wherein:
the first end of the first capacitor is connected to an (n+1)th storage capacitor bus line among the plurality of storage capacitor bus lines;
the gate electrode of the first output transistor is connected to the (n+1)th gate bus line among the plurality of gate bus lines;
the first end of the second capacitor is connected to an (n−1)th storage capacitor bus line among the plurality of storage capacitor bus lines; and
the gate electrode of the second output transistor is connected to the (n−1)th gate bus line among the plurality of gate bus lines.

6. A liquid crystal display device board comprising:
the liquid crystal display device circuit according to claim 1.

7. A liquid crystal display device comprising:
the liquid crystal display device board according to claim 6.

8. The liquid crystal display device circuit according to claim 2, wherein:
the first end of the first capacitor is connected to an (n+1)th storage capacitor bus line among the plurality of storage capacitor bus lines;
the gate electrode of the first output transistor is connected to the (n+1)th gate bus line among the plurality of gate bus lines;
the first end of the second capacitor is connected to an (n−1)th storage capacitor bus line among the plurality of storage capacitor bus lines; and
the gate electrode of the second output transistor is connected to the (n−1)th gate bus line among the plurality of gate bus lines.

9. A liquid crystal display device board comprising:
the liquid crystal display device circuit according to claim 2.

10. A liquid crystal display device comprising:
the liquid crystal display device board according to claim 9.
